(19) United States
(12) Patent Application Publication
(10) Pub. No.: US 2020/0039794 A1
(43) Pub. Date: Feb. 6, 2020

(54) LOST MOTION ASSEMBLY

(71) Applicant: Otis Elevator Company, Farmington, CT (US)

(72) Inventors: JungSam Kim, Seoul (KR); Jong-Kon Bae, Hwaseong-si (KR); Jinkoo Lee, Shanghai (CN); Michael J. Tracey, Cromwell, CT (US)

(21) Appl. No.: 16/528,236

(22) Filed: Jul. 31, 2019

(30) Foreign Application Priority Data
Aug. 2, 2018 (CN) 201810872150.X

(51) Int. Cl. B66B 13/06

(52) U.S. Cl. CPC B66B 13/06

(57) ABSTRACT

A lost motion assembly for synchronizing, in an elevator, an opening and closing of center opening doors responsive to a belt moving in a first direction and a second direction, the assembly having: a first link having a plurality of opposing ends, the opposing ends including a first end and a second end, wherein the first end is connected to the belt, the first link being connected at a first pivot to a first door for pivoting the first link in a first pivotal direction and an opposing second pivotal direction, and the first pivot being disposed intermediate the opposing ends, wherein when the belt moves in the first direction the first link pivots in the first pivotal direction and when the belt moves in the second direction the first link pivots in the second pivotal direction, and the first door remains stationary while the first link pivots.

### BACKGROUND

The embodiments herein relate to devices providing synchronized motion to center-opening elevator doors and specifically to a lost motion assembly.

Elevators may be configured with center opening doors that are belt driven. A belt may be attached to one of the doors a relating cable may be used to couple and synchronize the motion of the opposing panel. The use of a relating cable has maintenance and cost concerns.

### BRIEF SUMMARY

Disclosed is a lost motion assembly for synchronizing, in an elevator, an opening and closing of a plurality of center opening doors, the doors including at least a first door, wherein the doors open and close responsive to a belt moving in a respective plurality of directions including a first direction D1 and a second direction D2, the assembly comprising: a first link having a plurality of opposing ends, the opposing ends including a first end and a second end, wherein the first end is connected to the belt, the first link being connected at a first pivot to the first door for pivoting the first link in a first pivotal direction P1 and an opposing second pivotal direction P2, and the first pivot being disposed intermediate the opposing ends, wherein when the belt moves in the first direction D1 the first link pivots in the first pivotal direction P1 and when the belt moves in the second direction D2 the first link pivots in the second pivotal direction P2, and the first door remains stationary while the first link pivots.

In addition to one or more of the above disclosed features or as an alternate, the first link has a plurality of opposing sides, including a first side and a second side, and the assembly comprises: a plurality of motion limiters including a first motion limiter and second motion limiter, the first motion limiter adjacent the first side of the first link and the second motion limiter adjacent the second side of the first link, the plurality of motion limiters providing a pivotal range of motion for the first link, and wherein the first door opens with the belt when the first link pivots against the first motion limiter and the first door closes with the belt when the first link pivots against the second motion limiter.

In addition to one or more of the above disclosed features or as an alternate, the plurality of motion limiters are adjustable for adjusting a pivotal range of motion for the first link.

In addition to one or more of the above disclosed features or as an alternate, the assembly includes a plurality of links including the first link and a second link, the second link being pivotally connected to the first door at a second pivot, the second link being adjacent the second side of the first link, the second link pivotally latching the first link against the first motion limiter when the first link pivots in the first direction P 1.

In addition to one or more of the above disclosed features or as an alternate, the second link has a first end and an opposing second end, the second end of the second link having a hook member that latches against the second end of the first link to latch the first link against the first motion limiter.

In addition to one or more of the above disclosed features or as an alternate, second pivot includes a first biasing member which is a torsional biasing member for biasing the second link in the second direction so that the second end of the second link securely latches against the second end of the first link.

In addition to one or more of the above disclosed features or as an alternate, the assembly includes a second biasing member that biases the second end of the second link in the first direction to rotate the second link in the first pivotal direction, whereby the second link releases the first link when the first link pivots in the second direction for closing the first door.

In addition to one or more of the above disclosed features or as an alternate, the second biasing member is a spring loaded boss mounted proximate to the second link.

In addition to one or more of the above disclosed features or as an alternate, the first end of the first link is pivotally mounted to the belt by a clamp.

In addition to one or more of the above disclosed features or as an alternate, the plurality of links and plurality of motion limiters are mounted to a plate and the plate is mounted to the first door.

Further disclosed is a method of synchronizing, in an elevator having a lost motion assembly, an opening and closing of a plurality of center opening doors, the doors including at least a first door, wherein the doors open and close responsive to a belt moving in a respective plurality of directions including a first direction D1 and a second direction D2, the assembly including one or more of the above disclosed features. Yet further disclosed is a door for an elevator, where the door comprises a lost motion assembly containing one or more of the above disclosed features and elements.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates a lost motion assembly according to an embodiment attached to an elevator;

FIG. 3 illustrates a lost motion assembly according to an embodiment in one positional implementation; and

FIG. 4 illustrates a lost motion assembly according to an embodiment in another positional implementation.

### DETAILED DESCRIPTION

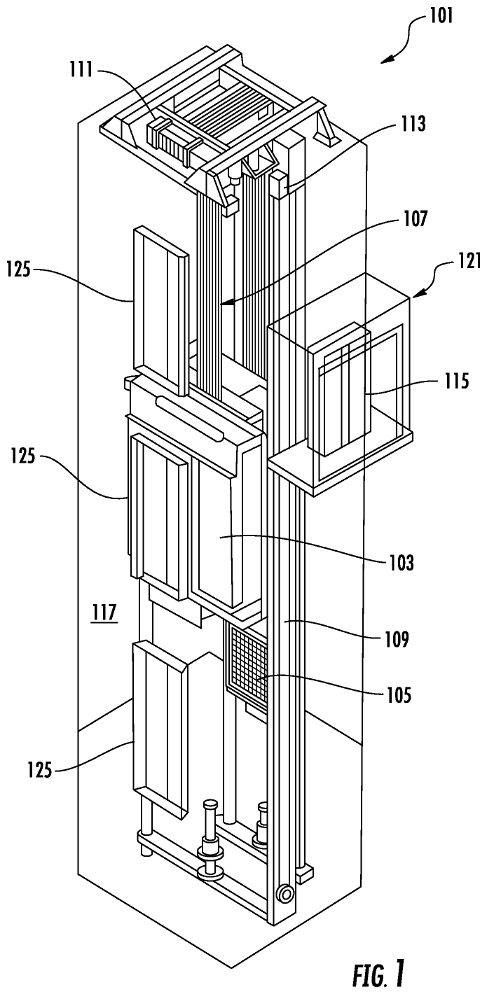

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

Turning to FIG. 2, a lost motion assembly 200 is disclosed for synchronizing, in an elevator 210, an opening and closing of a plurality of center opening doors. The doors may include a first door 220 and a second door 225. The doors may open responsive to a belt 230 moving in a first direction D1 and the doors may close response to the belt 230 moving in a second direction D2 that opposes the first direction D1. The belt 230 may be driven for example by a belt drive system that may include a motor 235 and pulley 237 illustrated schematically.

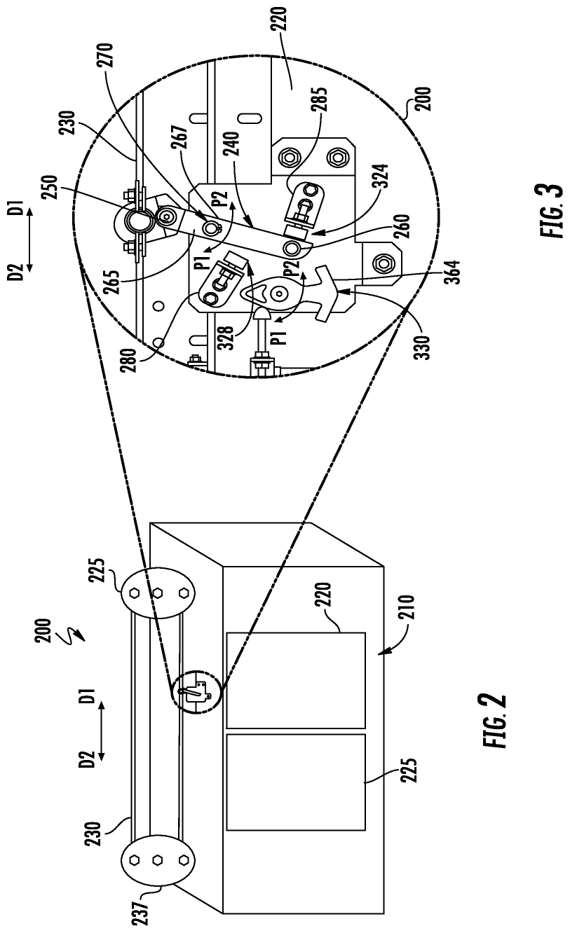

Turning to FIG. 3, the assembly 200 may comprise a first link 240 that is elongated and has a plurality of longitudinally opposing ends. The opposing ends of the first link 240 may include a first end 250 and a second end 260. The first link 240 may also have a plurality of transversely opposing sides including a first side 265 and a second side 267.

The first end 250 of the first link 240 may be connected to the belt 230 to move with the belt 230. The first link 240 may be connected at a first pivot 270 to the first door 220. The first pivot 270 may be disposed intermediate the opposing ends of the first link 240. The first pivot 270 may enable the first link 240 to pivot in opposing directions including a first pivot direction P1 and a second pivot direction P2. With this configuration, when the belt 230 moves in the first direction D1, the first link 240 may pivot in a first pivot direction P1. Similarly, when the belt 230 moves in the second direction D2 the first link 240 may pivot in a second pivot direction P2 that opposes the first pivot direction P1.

The assembly 200 may comprise a plurality of motion limiters including first motion limiter 280 and a second motion limiter 285. The first motion limiter 280 may be adjacent the first side 265 of the first link 240 and the second motion limiter 285 may be adjacent the second side 267 of the first link 240. The plurality of motion limiters may provide a pivotal range of motion for the first link 240 to pivot in the opposing pivotal directions P1, P2. The plurality of motion limiters may be individually adjustable to modify the pivotal range of motion from either or both pivotal directions P1, P2. With this configuration while the belt 230 moves in the first direction D1 the first door 220 may remain stationary until the first link 240 engages the first motion limiter 285. Due to the lost motion of the first door 220 in the first direction D1, both doors may open from the center in sync. While the belt 230 moves in the second direction D2 the first door 220 may remain stationary until the first link 240 engages the second motion limiter 285. Due to the lost motion of the first door 220 in the second direction D1, both doors may close towards the center in sync.

The motion limiters may include respective plurality of paddings, including a first padding 328 for the first motion limiter 280 and a second padding 324 for the second motion limiter 285. The paddings may be rubber used to prolong a useful life of the assembly 200.

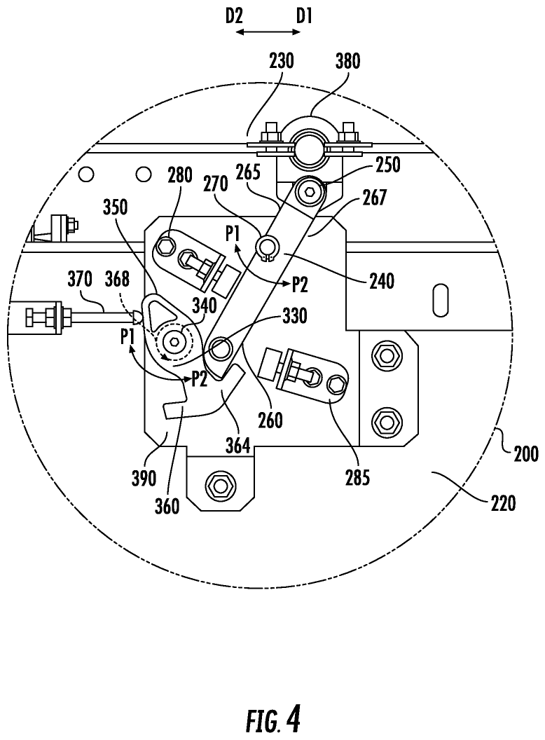

Turning to FIG. 4, the assembly 200 may include a plurality of links including the first link 240 and a second link 330. The second link 330 may be pivotally connected to the first door 220 at a second pivot 340 to pivotally engage the first link 240. The second link 330 may be adjacent the second side 260 of the first link 240. The second link 330 may have a plurality of longitudinally spaced ends including a third end 350 and a fourth end 360. The second pivot 340 may be disposed between the opposing ends of the second link 330.

The second link 330 may pivotally latch the first link 240 against the first motion limiter 280 when the first link 240 pivots in the first pivotal direction P1 and engages the first motion limiter 280. More specifically, the fourth end 360 of the second link 330 may include a first hook member 364 contoured to engage the second end 260 of the first link 240 when latching the first link 240 against the first motion limiter 280.

In addition, a first basing member 368 (illustrated schematically), which may be a rotational biasing member, may be provided at the second pivot 340. The first biasing member 368 may bias the second link 330 in the second pivotal direction P2 so that the latching is secure. The first biasing member 368 may be a torsional spring.

A second biasing member 370 may operationally engage the third end 350 of the second link 330 when the second link 330 has latched the first link 240 against the first motion limiter 285. When the belt 230 moves in the second direction D2, the first end 250 of the first link 240 may move with the belt 230 in the second direction D2. From this, the first link 240 may rotate in the second pivotal direction P2. As a result, the second biasing member 370 may bias the second link 330 to pivot in the first pivotal direction P1. The pivoting of the second link 330 may unlatch the first link 240, enabling the first link 240 to pivot in the second pivot direction P2 toward the second motion limiter 285, as indicated above.

In one embodiment the first end 250 may be pivotally mounted to the belt 230 by a clamp 380. This connection may provide rotational motion for the lever 240 relative to the belt 230. In one embodiment the assembly 200 may include a baseplate 390 that is mounted to the first door 220. The plurality of links and plurality of motion limiters may be mounted to baseplate 390 to facilitate packaging of the assembly 200.

During opening the belt moves the link from the first (close position) stopper to the second (open position) stopper. Once the lever touches the second stopper the door starts to move. As the door moves the catch moves away from the boss (which may be an adjustable stopper bolt) and rotates to latch the second end (lower part of the lever, or link), preventing the movement between the stoppers (or bumpers).

With the above disclosed embodiments the relative movement of the belt allows actuation of the assembly 200 while maintaining a synchronized position between opposing door panels. The disclosed embodiments may improve product life quality and noise performance over designs that use a relator with a wire.

The term “about” is intended to include the degree of error associated with measurements of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A lost motion assembly for synchronizing, in an elevator, an opening and closing of a plurality of center opening doors, the doors including at least a first door, wherein the doors open and close responsive to a belt moving in a respective plurality of directions including a first direction D1 and a second direction D2, the assembly comprising:
a first link having a plurality of opposing ends, the opposing ends including a first end and a second end, wherein the first end is connected to the belt,
the first link being connected at a first pivot to the first door for pivoting the first link in a first pivotal direction P1 and an opposing second pivotal direction P2, and the first pivot being disposed intermediate the opposing ends,
wherein when the belt moves in the first direction D1 the first link pivots in the first pivotal direction P1 and when the belt moves in the second direction D2 the first link pivots in the second pivotal direction P2, and
the first door remains stationary while the first link pivots.

2. The assembly of claim 1 wherein
the first link has a plurality of opposing sides, including a first side and a second side, and the assembly comprises:
a plurality of motion limiters including a first motion limiter and second motion limiter, the first motion limiter adjacent the first side of the first link and the second motion limiter adjacent the second side of the first link, the plurality of motion limiters providing a pivotal range of motion for the first link, and
wherein the first door opens with the belt when the first link pivots against the first motion limiter and the first door closes with the belt when the first link pivots against the second motion limiter.

3. The assembly of claim 2 wherein
the plurality of motion limiters are adjustable for adjusting a pivotal range of motion for the first link.

4. The assembly of claim 3 including
a plurality of links including the first link and a second link, the second link being pivotally connected to the first door at a second pivot, the second link being adjacent the second side of the first link, the second link pivotally latching the first link against the first motion limiter when the first link pivots in the first direction P1.

5. The assembly of claim 4 wherein
the second link has a first end and an opposing second end, the second end of the second link having a hook member that latches against the second end of the first link to latch the first link against the first motion limiter.

6. The assembly of claim 5 wherein
second pivot includes a first biasing member which is a torsional biasing member for biasing the second link in the second direction so that the second end of the second link securely latches against the second end of the first link.

7. The assembly of claim 6 comprising
a second biasing member that biases the second end of the second link in the first direction to rotate the second link in the first pivotal direction, whereby the second link releases the first link when the first link pivots in the second direction for closing the first door.

8. The assembly of claim 7 wherein
the second biasing member is a spring loaded boss mounted proximate to the second link.

9. The assembly of claim 8 wherein
the first end of the first link is pivotally mounted to the belt by a clamp.

10. The assembly of claim 9 wherein
the plurality of links and plurality of motion limiters are mounted to a plate and the plate is mounted to the first door.

11. A method of synchronizing, in an elevator having a lost motion assembly, an opening and closing of a plurality of center opening doors with a lost motion assembly, the doors including at least a first door, wherein the doors open and close responsive to a belt moving in a respective plurality of directions including a first direction D1 and a second direction D2,
the assembly including:
a first link having a plurality of opposing ends, the opposing ends including a first end and a second end, wherein the first end is connected to the belt,
the first link being connected at a first pivot to the first door for pivoting the first link in a first pivotal direction P1 and an opposing second pivotal direction P2, and the first pivot being disposed intermediate the opposing ends,
wherein the method comprises moving the belt in the first direction D1 to pivot the first link pivots in the first pivotal direction P1, moving the belt in the second direction D2 to pivot the first link pivot in the second pivotal direction P2, and
wherein the first door remains stationary while the first link pivots.

12. The method of claim 1 wherein
the first link has a plurality of opposing sides, including a first side and a second side, and the assembly comprises:
a plurality of motion limiters including a first motion limiter and second motion limiter, the first motion limiter adjacent the first side of the first link and the second motion limiter adjacent the second side of the first link, the plurality of motion limiters providing a pivotal range of motion for the first link, and
wherein the first door opens with the belt when the first link pivots against the first motion limiter and the first door closes with the belt when the first link pivots against the second motion limiter.

13. The method of claim 12 wherein
the plurality of motion limiters are adjustable for adjusting a pivotal range of motion for the first link.

14. The method of claim 13 including
a plurality of links including the first link and a second link, the second link being pivotally connected to the first door at a second pivot, the second link being adjacent the second side of the first link, the second link pivotally latching the first link against the first motion limiter when the first link pivots in the first direction P1.

15. The method of claim 14 wherein
the second link has a first end and an opposing second end, the second end of the second link having a hook member that latches against the second end of the first link to latch the first link against the first motion limiter.

16. The method of claim 15 wherein
second pivot includes a first biasing member which is a torsional biasing member for biasing the second link in the second direction so that the second end of the second link securely latches against the second end of the first link.

17. The method of claim 16 comprising
a second biasing member that biases the second end of the second link in the first direction to rotate the second link in the first pivotal direction, whereby the second link releases the first link when the first link pivots in the second direction for closing the first door.

18. The method of claim 17 wherein
the second biasing member is a spring loaded boss mounted proximate to the second link.

19. The method of claim 18 wherein
the first end of the first link is pivotally mounted to the belt by a clamp.

20. A door for an elevator, the door comprising the assembly of claim 1.
